(19) United States
(12) Patent Application Publication
(10) Pub. No.: US 2026/0105149 A1
(43) Pub. Date: Apr. 16, 2026

(54) System and method for malicious code detection via component behavior analysis

(71) Applicant: Bank of America Corporation, Charlotte, NC (US)

(72) Inventors: Jack Bishop, Evanston, IL (US); Jason C. Starin, Huntersville, NC (US); Adam B. Richman, Charlotte, NC (US)

(21) Appl. No.: 18/915,973

(22) Filed: Oct. 15, 2024

(51) Int. Cl. G06F 21/56

(52) U.S. Cl. CPC G06F 21/56; G06F 2221/033

(57) ABSTRACT

A system for detecting and mitigating malicious software components is disclosed. The system identifies a first component shared between a known malicious application and a software application in question. The system extracts metadata for malicious application and software application, compares metadata vectors associated with malicious application and software application, and determines the component usage patterns for each. The system determines a similarity score between the component usage pattern. If the similarity score exceeds a threshold, the system generates an instrumented component to replace the first component. The instrumented component, when executed by a processor, causes the processor, to perform an expected function of the first component. The system executes the software application with the instrumented component. If the operation of the software application deviates from an expected operation, the system identifies the first component as malicious and deploys a security patch.

### TECHNICAL FIELD

The present disclosure relates generally to network security, and more specifically to a system and method for malicious code detection via component behavior analysis.

### BACKGROUND

Organizations often utilize various software applications to support and manage their operations. The software applications may be vulnerable to cyberattacks.

### SUMMARY

The disclosed system, described in the present disclosure, is particularly integrated into a practical application to improve malicious software component detection and mitigation techniques.

In conventional systems, detecting malicious software components (also referred to herein as malicious components) may include manually investigating the code associated with each suspicious software component. However, with the rise of more sophisticated malicious components, bad actors implement deliberately confusing and/or seemingly legitimate code structures to obfuscate the underlying malicious intent of the code. Even using brute force to try to decode or determine the true intent of such code may fall short to detect the actual intent of the code as it may be obfuscated. One example of malicious software components may include malware that is configured to perform certain malicious activities to disrupt an operation of a computing device by creating dummy files to slow down the speed and performance of the computing device, corrupting files, or crashing some software or executable applications so that they cannot be executed. In another example, a malicious component may access sensitive data, such as personal information without authorization. In another example, a malicious component may exfiltrate data by transmitting confidential data to unauthorized devices. In some cases, a malicious component may include a combination of several malicious code toolkits that may or may not be known as malicious and/or include a new code structure to obfuscate the underlying intent of the malicious code. The conventional systems lack the capability to accurately and efficiently detect and mitigate such malicious code. This leaves the computing devices vulnerable to malicious attacks. By deleting/quarantining, or otherwise addressing the malicious code, computing systems are allowed to operate without disruption, sensitive data is kept secure from unauthorized access, and potential data exfiltration is reduced or eliminated.

The disclosed system is configured to provide a solution to these and other technical problems currently rising in the realm of data security, network security, and malicious component detection and mitigation technologies. In some embodiments, instead of attempting to reverse engineer code in question to determine its actual intent/function (which may be deliberately obfuscated via confusing code structure) as done in the conventional systems, the disclosed system is configured to analyze the behavior of the code by simulating various triggering inputs to the code to cause the code to execute its actual function – even if it is obfuscated. Thus, the actual function/intent of the code may be determined and any malicious intent identified and addressed. The reverse engineering code approach suffers from drawbacks including inaccuracy – leaving the actual malicious intent of the code undetected. Another drawback of the reverse engineering approach is falling for traps that back actors put in place within the malicious code in an attempt to hide the malicious function of the code. The reverse engineering code approach leads to wasting processing and memory resources that are spent in reverse engineering the code without uncovering the actual malicious behavior of the code.

In some embodiments, the disclosed system is configured to extract and analyze metadata from malicious applications and determine patterns and behavior indicative of malicious activities from the extracted metadata. The extracted metadata may include data packets, computer-readable code, compiled code, decompiled code, and the like.

The disclosed system provides several technical improvements to the detection and mitigation of malicious software component technology. Some of these technical improvements are described below in conjunction with certain embodiments of the disclosed system. In some embodiments, the disclosed system is configured to implement machine learning algorithms to cluster malicious software applications that share common components. The clustering or classification of malicious software applications may provide information that the disclosed system may use to identify patterns and behavior of malicious activities shared across a given group of malicious software applications. This, in turn, increases the accuracy of detecting new security threats that may share common components and/or malicious behavior with previously identified malicious software applications. As a result, the disclosed system may identify potentially malicious software based on its common components and/or behavior with a class of previously identified malicious software applications, even if the potentially malicious software application has not been previously encountered by the disclosed system.

In some embodiments, the disclosed system is configured to generate instrumented software components that are configured to monitor and log interactions and behaviors of the software application, while performing the intended non-malicious function of the suspicious software component, in a controlled testing environment to detect malicious or unexpected actions. The disclosed system is configured to replace a suspicious software component with the counterpart instrumented software component and test the software application by replacing the suspicious software component with the counterpart instrumented software component.

In some embodiments, the disclosed system is configured to generate test cases to execute a software application that is suspected of being infected by malicious code. For example, the disclosed system may use machine learning algorithms to analyze the behavior of known malicious components and identify patterns or sequences of operations that are likely to indicate malicious activity, along with events that trigger the malicious activities. Based on this analysis, the disclosed system generates test cases that simulate various scenarios and inputs to interact with the software application suspected of being infected with a malicious software component under a testing environment. The test cases may be configured to trigger specific responses or interactions from the components of the software application. In the testing phase, the disclosed system may observe the operations/behavior of the software application in question to determine any deviation from an unexpected operation/behavior. If a deviation from the expected operation/behavior is detected, the disclosed system may determine that the suspicious software component is indeed malicious. Otherwise, the disclosed system may determine that the suspicious software component is not malicious. In this manner, the disclosed system provides practical applications to improve the current data security, network security, and malicious code detection and mitigation techniques. This, in turn, improves the underlying functions of the computer systems used to host the software components and their associated data. Specifically, the disclosed system improves the current data security techniques by proactively identifying and isolating malicious components before they can access or compromise sensitive data stored in computing systems. For example, before a malicious component has a chance to attempt to exfiltrate sensitive data or manipulate stored information, the system detects the malicious component and mitigates unauthorized data access (e.g., by quarantining or deleting the malicious component). The disclosed system improves the network security techniques by monitoring interactions between software applications (at the computing device in question) and external computing systems. By identifying suspicious behaviors, such as unauthorized attempts for network connections or data transfers, or attempts to communicate with external unauthorized servers, the disclosed system may detect and mitigate such malicious activities (e.g., by quarantining or deleting the malicious component). For example, the disclosed system may detect malware attempting to establish network communication with an unauthorized server and block such communication. The disclosed system improves the malicious code detection and mitigation techniques by proactively detecting and mitigating malicious code (e.g., by quarantining or deleting the malicious code). For example, by quarantining or deleting the malicious code, the disclosed system allows legitimate software applications to run without disruptions or interference, and instances of legitimate software applications being infected by the malicious code are reduced.

In some embodiments, a system comprises a memory operably coupled with a processor. The memory is configured to store a first malicious application. The processor is configured to extract first component metadata from the first malicious application, wherein the first component metadata comprises one or more component identifiers associated with one or more components of the first malicious application. The processor is further configured to extract second component metadata from a first software application, wherein the second component metadata comprises one or more component identifiers associated with one or more components of the first software application. The processor is further configured to compare the second component metadata with the first component metadata. The processor is further configured to determine that the first software application has more than a threshold percentage of components in common with the first malicious application based at least in part upon the comparison between the second component metadata and the first component metadata. The processor is further configured to identify a first component that is common between the first software application and the first malicious application in response to determining that the first software application has more than the threshold percentage of components in common with the first malicious application. The processor is further configured to determine a first component usage associated with the first component by the first software application.

The processor is further configured to determine a second component usage associated with the first component by the first malicious application. The processor is further configured to determine that a similarity score between the first component usage and the second component usage is more than a threshold similarity score based at least in part upon the first component usage and the second component usage. The processor is further configured to generate an instrumented component associated with the first component, wherein the instrumented component, when executed by the processor, causes the processor to perform an expected non-malicious function of the first component. The processor is further configured to replace the first component of the first software application with the generated instrumented component. The processor is further configured to execute the first software application with the generated instrumented component. The processor is further configured to determine an operation of the first software application with respect to the generated instrumented component, wherein the operation of the first software application with respect to the generated instrumented component indicates whether the first component has altered an expected operation of the first software application. The processor is further configured to determine that the operation of the first software application deviates from an initial operation of the first software application where the first component is implemented in the first software application. The processor is further configured to determine that the first component is a malicious component in response to determining that the operation of the first software application deviates from the initial operation of the first software application where the first component is implemented in the first software application. The processor is further configured to execute a security patch to address the malicious component, for example, by deleting or quarantining the malicious component.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured to detect and mitigate malicious software components;

FIG. 2 illustrates an example operational flow of the system of FIG. 1; and

FIGS. 3A and 3B an example flow chart of a method of the system of FIG. 1.

### DETAILED DESCRIPTION

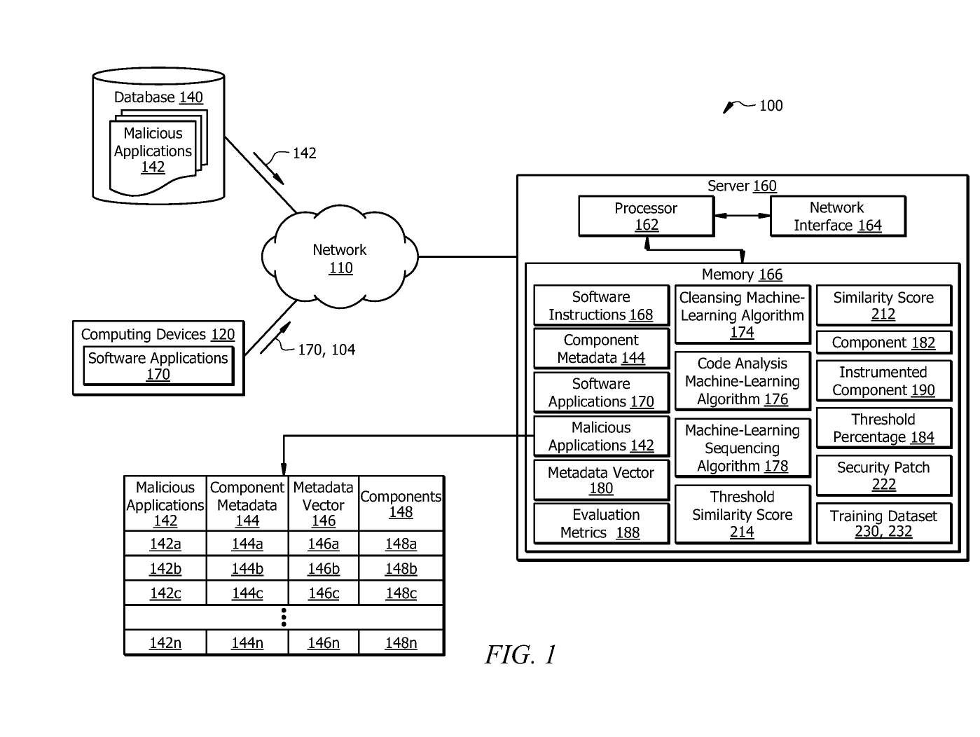

As described above, previous technologies fail to provide efficient and reliable solutions to detect and mitigate malicious software components. Embodiments of the present disclosure and its advantages may be understood by referring to FIGS. 1 through 3B. FIGS. 1 through 3B are used to describe systems and methods to detect and mitigate malicious software components, according to some embodiments.

### System overview

FIG. 1 illustrates an embodiment of a system 100 that is generally configured to detect and mitigate malicious software components (e.g., files, code, libraries, executable files, etc.) that may be used for unauthorized data exfiltration. In some embodiments, the system 100 comprises a server 160 communicatively coupled with one or more computing devices 120 and a database 140 via a network 110. The network 110 enables the communication among the components of the system 100. Each computing device 120 may be used to send data to and receive data from other components of the system 100. The database 140 stores records of malicious software application 142, also referred to herein as malicious applications. The information stored in the database 140 may be used by other components of the system 100 to perform certain functions as described herein. The database 140 may store information that may be used by one or more components of the system 100. The server 160 is configured to detect and mitigate malicious software components according to certain embodiments described herein. In other embodiments, system 100 may not have all of the components listed and/or may have other elements instead of, or in addition to, those listed above.

In general, the system 100 improves the malicious software component detection and mitigation techniques. In current systems, detecting malicious software components (also referred to herein as malicious components) may include manually investigating the code associated with each suspicious software component. However, with the rise of more sophisticated malicious components bad actors implement deliberately confusing and/or seemingly legitimate code structures to obfuscate the underlying malicious intent of the code. Even using brute force to try decoding or determine the true intent of such code may fall short to detect the actual intent of the code as it may be obfuscated. One example of malicious software components may include malware that is configured to perform certain malicious activities to disrupt an operation of a computing device, access sensitive data, exfiltrate data, etc. In some cases, a malicious component may include a combination of several malicious code toolkits that may or may not be known as malicious and/or include a new code structure to obfuscate the underlying intent of the malicious code. The current systems lack the capability to accurately and efficiently detect and mitigate such malicious code.

The system 100 is configured to provide a solution to these and other technical problems currently rising in the realm of data security, network security, and malicious component detection and mitigation technologies. In some embodiments, instead of attempting to reverse engineer code in question to determine its actual intent/function (which may be deliberately obfuscated via confusing code structure) as done in the conventional systems, the system 100 is configured to analyze the behavior of the code by simulating various triggering inputs to the code to cause the code to execute its actual function – even it is obfuscated. Thus, the actual function/intent of the code may be determined and any malicious intent identified and addressed. The reverse engineering code approach suffers from drawbacks including inaccuracy – leaving the actual malicious intent of the code undetected.

The disclosed system provides several technical improvements to the detection and mitigation of malicious software component technology. Some of these technical improvements are described below in conjunction with certain embodiments of the disclosed system. In some embodiments, the system 100 is configured to extract and analyze metadata from malicious applications 142 and determine patterns and behavior indicative of malicious activities from the metadata. The metadata may include data packets, computer-readable code, compiled code, decompiled code, and the like.

In some embodiments, the system 100 is configured to implement machine learning algorithms to cluster malicious software applications that share common components. The clustering or classification of malicious software applications may provide information that the system 100 may use to identify patterns and behavior of malicious activities shared across a given group of malicious software applications. This, in turn, increases the accuracy of detecting new security threats that may share common components and/or malicious behavior with previously identified malicious software applications. As a result, the system 100 may identify potentially malicious software based on its common components and/or behavior with a class of previously identified malicious software applications, even if the potentially malicious software application has not been previously encountered by the system 100.

In some embodiments, the system 100 is configured to generate instrumented software components that are configured to monitor and log interactions and behaviors of the software application, while performing the intended non-malicious function of the suspicious software component, in a controlled testing environment to detect malicious or unexpected actions. The system 100 is configured to replace a suspicious software component with the counterpart instrumented software component and test the software application by replacing the suspicious software component with the counterpart instrumented software component.

In some embodiments, the system 100 is configured to generate test cases to execute a software application that is suspected of being infected by malicious code. For example, the system 100 may use machine learning algorithms to analyze the behavior of known malicious components and identify patterns or sequences of operations that are likely to indicate malicious activity, along with events that trigger the malicious activities. Based on this analysis, the system 100 generates test cases that simulate various scenarios and inputs to interact with the software application suspected of being infected with a malicious software component under a testing environment. The test cases may be configured to trigger specific responses or interactions from the components of the software application. In the testing phase, the system 100 may observe the operations/behavior of the software application in question to determine any deviation from an unexpected operation/behavior. If a deviation from the expected operation/behavior is detected, the system 100 may determine that the suspicious software component is indeed malicious. Otherwise, the system 100 may determine that the suspicious software component is not malicious. In this manner, the system 100 provides practical applications to improve the current data security, network security, and malicious code detection and mitigation techniques. This, in turn, improves the underlying functions of the computer systems used to host the software components and their associated data. Specifically, the disclosed system improves the current data security techniques by proactively identifying and isolating malicious components before they can access or compromise sensitive data stored in computing systems. For example, before a malicious component has a chance to attempt to exfiltrate sensitive data or manipulate stored information, the system detects the malicious component and mitigates unauthorized data access (e.g., by quarantining or deleting the malicious component). The disclosed system improves the network security techniques by monitoring interactions between software applications (at the computing device in question) and external computing systems. By identifying suspicious behaviors, such as unauthorized attempts for network connections or data transfers, or attempts to communicate with external unauthorized servers, the disclosed system may detect and mitigate such malicious activities (e.g., by quarantining or deleting the malicious component). For example, the disclosed system may detect malware attempting to establish network communication with an unauthorized server and block such communication. The disclosed system improves the malicious code detection and mitigation techniques by proactively detecting and mitigating malicious code (e.g., by quarantining or deleting the malicious code). For example, by quarantining or deleting the malicious code, the disclosed system allows legitimate software applications to run without disruptions or interference, and instances of legitimate software applications being infected by the malicious code are reduced.

### System components

### Network

Network 110 may be any suitable type of wireless and/or wired network. The network 110 may be connected to the Internet or public network. The network 110 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., Wi-Fi, WiGig, WiMAX, etc.), a long-term evolution (LTE) network, a universal mobile telecommunications system (UMTS) network, a peer-to-peer (P2P) network, a Bluetooth network, a near-field communication (NFC) network, and/or any other suitable network. The network 110 may include fiber optics, optical fibers, and the like to implement quantum communication channels. The network 110 may be configured to support any suitable type of communication protocol as would be appreciated by one of ordinary skill in the art.

### Example computing device

Each computing device 120 may be generally any device that is configured to process data and interact with users. Examples of the computing device 120 include but are not limited to, a personal computer, a desktop computer, a workstation, a server, a laptop, a tablet computer, a mobile phone (such as a smartphone), smart glasses, virtual reality (VR) glasses, a virtual reality device, an augmented reality device, an internet-of-things (IoT) device, or any other suitable type of device. The computing device 120 may include a user interface, such as a display, a microphone, a camera, a keypad, or other appropriate terminal equipment usable by users. The computing device 120 may include a hardware processor, memory, and/or circuitry configured to perform any of the functions or actions of the computing device 120 described herein. In the present disclosure, the computing device 120 may be interchangeably referred to as a computing device or a user device.

Each computing device 120 includes a processor in signal communication with a network interface and a memory. The memory stores software instructions that when executed by the processor cause the processor to perform one or more operations of the computing device described herein. The computing device 120 is configured to communicate with other devices and components of the system 100 via the network 110. A user may use a computing device 120 to transmit data (e.g., software applications 170, etc.) to another device (e.g., server 160) along with a request message 104 to investigate or evaluate the software applications 170 for detecting potential malware components.

### Example Database

The database 140 generally comprises any storage architecture. Examples of the database 140, include, but are not limited to, a network-attached storage cloud, a storage area network, a data lake, a data warehouse, and a storage assembly directly (or indirectly) coupled to one or more components of the system 100. The database 140 may store malicious software applications 142. Each malicious software application 142 may be previously known to be malicious.

In some embodiments, the system 100 (e.g., via the server 160) may obtain records of malicious software applications 142 from various sources. The sources may include, for example, network security organizations, websites that provide records of known exploited security vulnerabilities, blogs, and open-source repositories, among others. In some examples, a malicious software application 142 may be malware, spyware, etc. Each malicious software application 142 may be configured to perform a malicious activity, such as damage data, disrupt data, exfiltrate data, or gain unauthorized access to a computing system, among others.

### Example Server

The server 160 generally includes a hardware computer system configured to detect and mitigate malicious software components (e.g., files, code, libraries, executable files, etc.). In certain embodiments, the server 160 may be implemented by a cluster of computing devices, such as virtual machines. For example, the server 160 may be implemented by a plurality of computing devices using distributed computing and/or cloud computing systems in a network. In certain embodiments, the server 160 may be configured to provide services and resources (e.g., data and/or hardware resources as described herein, etc.) to other components and devices.

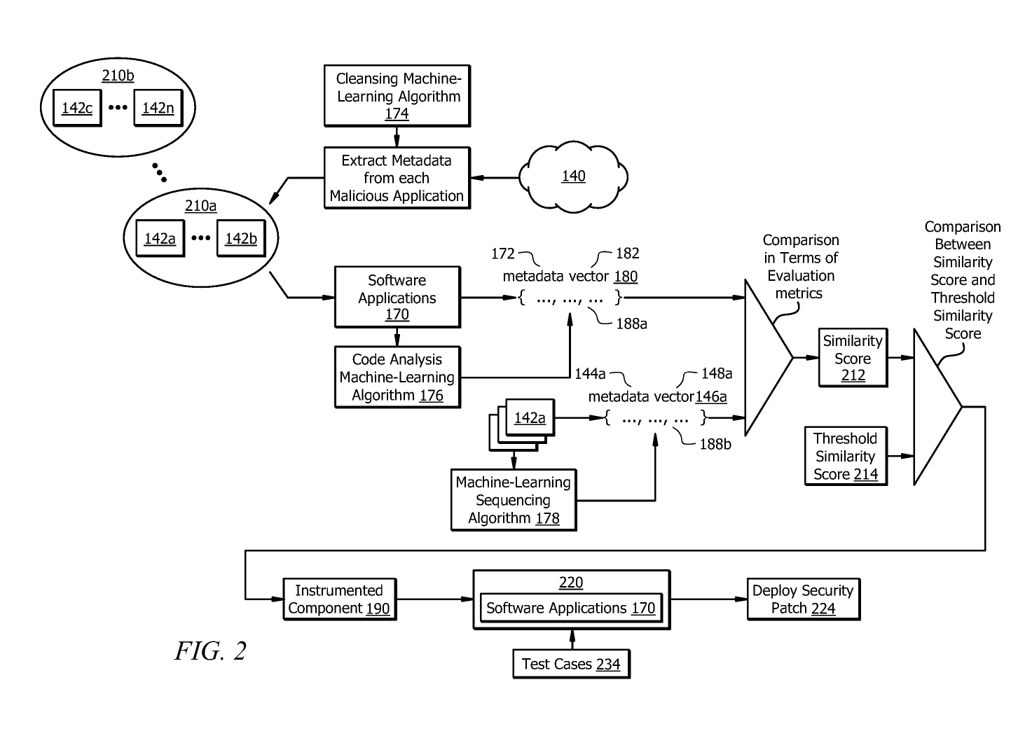

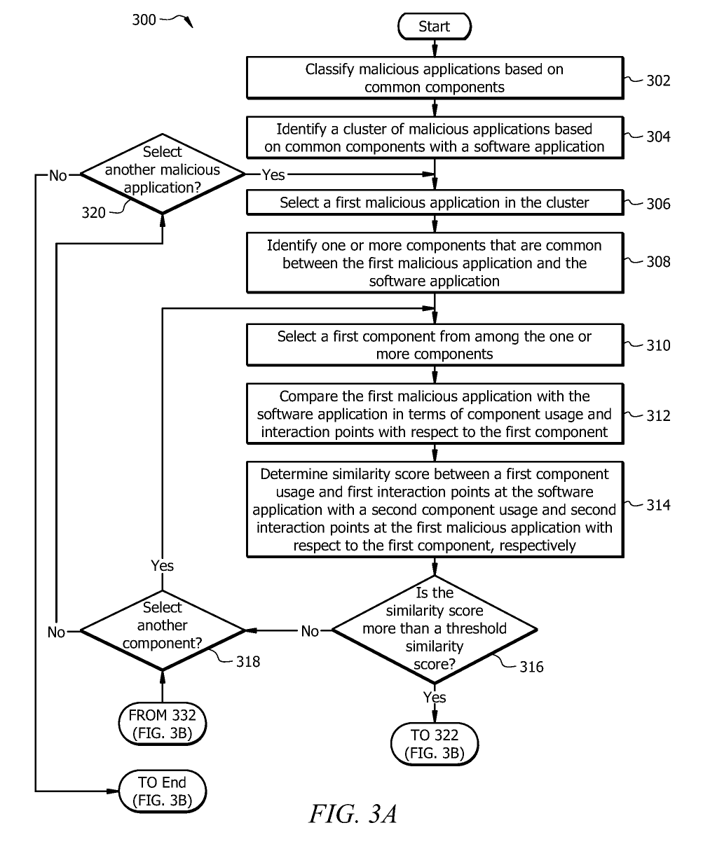

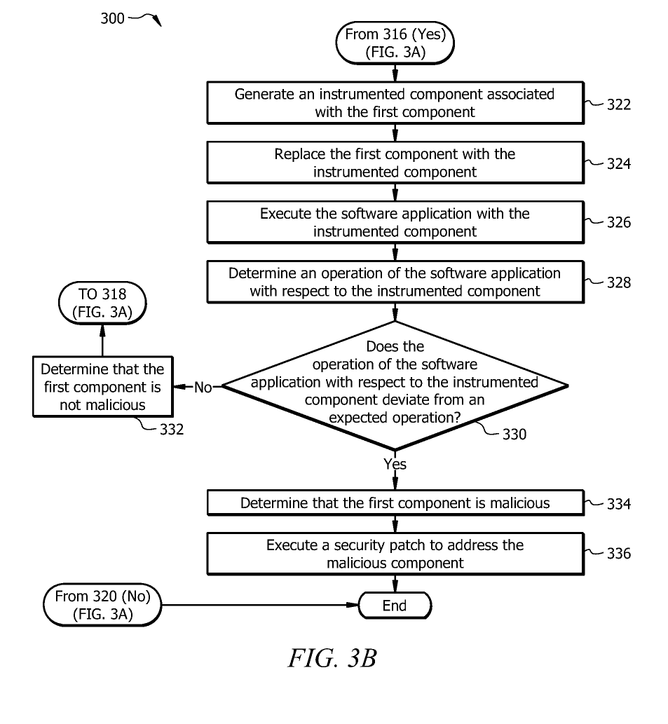

Server 160 may comprise a processor 162 operably coupled with a network interface 164 and a memory 166. Processor 162 comprises one or more processors. The processor 162 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors may be implemented in cloud devices, servers, virtual machines, and the like. The processor 162 may be a programmable logic device, a microcontroller, a microprocessor, or any suitable number and combination of the preceding. The one or more processors are configured to process data and may be implemented in hardware or software. For example, the processor 162 may be 8-bit, 16-bit, 32-bit, 64-bit, or of any other suitable architecture. The processor 162 may include an arithmetic logic unit (ALU) for performing arithmetic and logic operations. The processor 162 may register the supply operands to the ALU and store the results of ALU operations. The processor 162 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 168) to perform the operations of the server 160 described herein. In this way, processor 162 may be a special-purpose computer designed to implement the functions disclosed herein. In an embodiment, the processor 162 is implemented using logic units, FPGAs, ASICs, DSPs, or any other suitable hardware. The processor 162 is configured to operate as described in FIGS. 1-3B. For example, the processor 162 may be configured to perform one or more operations of the operational flow 200 of the system 100 described in FIG. 2 and one or more operations of the method 300 as described in FIGS. 3A and 3B.

Network interface 164 is configured to enable wired and/or wireless communications. The network interface 164 may be configured to communicate data between the server 160 and other devices, systems, or domains. For example, the network interface 164 may comprise a near field communication (NFC) interface, a Bluetooth interface, a Zigbee interface, a Z-Wave interface, a radio-frequency identification (RFID) interface, a wireless fidelity (Wi-Fi) interface, a local area network (LAN) interface, a wide area network (WAN) interface, a metropolitan area network (MAN) interface, a personal area network (PAN) interface, a wireless personal area network (WPAN) interface, a modem, a switch, and/or a router. The processor 162 may be configured to send and receive data using the network interface 164. The network interface 164 may be configured to use any suitable type of communication protocol.

The memory 166 may be a non-transitory computer-readable medium. The memory 166 may be volatile or non-volatile and may comprise read-only memory (ROM), random-access memory (RAM), ternary content-addressable memory (TCAM), dynamic random-access memory (DRAM), and/or static random-access memory (SRAM). The memory 166 may include one or more of a local database, a cloud database, a network-attached storage (NAS), etc. The memory 166 comprises one or more disks, tape drives, or solid-state drives, and may be used as an over-flow data storage device, to store programs when such programs are selected for execution, and to store instructions and data that are read during program execution. The memory 166 may store any of the information described in FIGS. 1-3B along with any other data, instructions, logic, rules, or code operable to implement the function(s) described herein when executed by processor 162. For example, the memory 166 may store software instructions 168, software applications 170, component metadata 172, metadata vector 180, components 182, malicious applications 142a-n, component metadata 144a-n, , metadata vectors 180, 146a-n, components 148, evaluation metrics 188a-b, instrumented components 190, cleansing machine learning algorithm 174, code analysis machine learning algorithm 176, machine learning sequencing algorithm 178, threshold percentage 184, similarity score 212, threshold similarity score 214, security patch 224, training datasets 230 and 232, and/or any other data or instructions. The software instructions 168 may comprise any suitable set of instructions, logic, rules, or code operable to execute the processor 162 and perform the functions described herein, such as some or all of those described in FIGS. 1-3B.

The server 160 may determine the component metadata 172 by monitoring performance metrics of the computing devices 120 and software application 170, querying the computing devices 120 and/or the software application 170 for their status, collecting logs, and analyzing system health reports, among others. This process is described further below in great detail. In some embodiments, the server 160 may monitor and evaluate each software application 170 residing on one or more computing devices 120. For example, the server 160 may have access to the software applications 170 and other components stored in each computing device 120 and monitor and receive metadata, logs, and other relevant data from the computing devices 120 executing software applications 170.

The cleansing machine learning algorithm 174 may be implemented by the processor 162 executing the software instructions 168 and is generally configured to classify malicious applications 142 that share common components 148 together. The cleansing machine learning algorithm 174 may comprise a support vector machine, neural network, random forest, k-means clustering, etc. The cleansing machine learning algorithm 174 may be implemented by a plurality of augmented neural network layers, neural network layers, convolutional layers, long-short-term-memory (LSTM) layers, Bi-directional LSTM layers, recurrent neural network layers, and the like. In some examples, the cleansing machine learning algorithm 174 may be implemented by a combination of deep learning architectures and neural networks for feature extraction and other operations. The cleansing machine learning algorithm 174 may be implemented by unsupervised, supervised, and/or semi-supervised machine learning techniques.

The cleansing machine learning algorithm 174 may classify malicious applications 142 that share common components 148 together. For example, the cleansing machine learning algorithm 174 may classify malicious applications 142 that share more than a threshold percentage (e.g., more than 80%, 90%, etc.) of their components 148 with each other and/or share more than a threshold percentage (e.g., more than 80%, 90%, etc.) of their component metadata 144 with each other. For example, a malicious application 142 may be fed to the cleansing machine learning algorithm 174 and the cleansing machine learning algorithm 174 may identify the components 148 of the malicious application 142. Some examples of components 148 may include software modules or libraries, such as dynamic link libraries (DLLs), Java frameworks, Java code file, shared objects, executable files, executable code, scripts, drivers, plug-ins, configuration files, or any other software components that interact with or are utilized by a software application.

The cleansing machine learning algorithm 174 may identify the components 148a, 148b, 148c, and 148n of the respective malicious applications 142a, 142b, 142c, and 142n. The cleansing machine learning algorithm 174 may identify each component 148 based on their names, titles, content, associations/dependencies with components 148, among others. In response, the cleansing machine learning algorithm 174 may identify which malicious applications 142 share more than a threshold percentage of their components 148 with each other and cluster them together.

The cleansing machine learning algorithm 174 may extract a set of component metadata 144 from each malicious application 142. For example, a malicious application 142 may be fed to the cleansing machine learning algorithm 174 and the cleansing machine learning algorithm 174 may identify the components of the malicious application 142 and divide the components into smaller sections for evaluation. In this process, the cleansing machine learning algorithm 174 may use code segmentation, text segmentation, code tokenization, text tokenization, and the like.

The cleansing machine learning algorithm 174 may analyze the content of each section to identify various features and characteristics. For example, the cleansing machine learning algorithm 174 may determine the variables, parameters, code functions, classes, libraries, instructions, and other elements of each section of the malicious application 142. The cleansing machine learning algorithm 174 may determine the component metadata 144 associated with the malicious application 142. The component metadata 144 may include each component identifier, each component usage pattern, entry and exit points of each component, dependencies between the components, and interactions with the operating system and other software application, among others. The component metadata 144 may be represented by a metadata vector 146 that comprises numerical values that represent the component metadata 144 in the vector space.

For example, the cleansing machine learning algorithm 174 may extract the component metadata 144a, 144b, 144c, and 144n from the respective malicious applications 142a, 142b, 142c, and 142n, where each component metadata 144a, 144b, 144c, and 144n is represented by the metadata vectors 146a, 146b, 146c, and 146n, respectively. Additionally, the cleansing machine learning algorithm 174 may implement feature selection methods to identify the relevant attributes from the metadata vectors 146 to distinguish between malicious and non-malicious activities and/or components. For example, a malicious activity may be identified by unusual patterns of network traffic that deviate from a respective expected baseline data, unusual patterns of network data packets that deviate from an expected baseline data, unauthorized attempts to access restricted files or system resources, as indicated in the respective component metadata 144.

The cleansing machine learning algorithm 174 may be trained by a training dataset 230 that comprises a set of malicious applications 142, where each of these is labeled with its respective metadata 144 and/or malicious component(s) 148. In the training phase, the cleansing machine learning algorithm 174 may use the training dataset 230 to learn the associations between each malicious application 142 and its respective label. The cleansing machine learning algorithm 174 may adjust the parameters of its neural network, including bias and weight values of the perceptrons to reduce the error between the predicted output (predicted labels) and the actual labels provided in the training dataset 230 for each malicious applications 142.

During the training process, the neural network iteratively analyzes each malicious application 142 and its label, and updates the bias and weight values through backpropagation to reduce the error in the prediction of the corresponding label of each malicious application 142, until the prediction accuracy reaches a predefined percentage, e.g., more than 90%, etc. In response, in the testing phase, the cleansing machine learning algorithm 174 may use the updated bias and weight values of its neural network to apply its learning to new, unseen applications (e.g., malicious applications 142 without labels).

The cleansing machine learning algorithm 174 may predict the likelihood that a given application (e.g., malicious application 142) includes malicious components by extracting its component metadata 144 and determining whether it includes any indication of malicious activity or malicious component based on the learned patterns and associations from the training dataset 230. The cleansing machine learning algorithm 174 may use this information to classify the malicious applications 142 that share common metadata 144 and/or malicious component(s) 148.

The code analysis machine learning algorithm 176 may be implemented by the processor 162 executing the software instructions 168 and is generally configured to analyze the content of each code section of a software application 170 to identify various features and characteristics associated with each code section. The code analysis machine learning algorithm 176 may comprise a support vector machine, neural network, random forest, k-means clustering, etc. The code analysis machine learning algorithm 176 may be implemented by a plurality of augmented neural network layers, neural network layers, convolutional layers, long-short-term-memory (LSTM) layers, Bi-directional LSTM layers, recurrent neural network layers, and the like. In some examples, the code analysis machine learning algorithm 176 may be implemented by a combination of deep learning architectures and neural networks for code analysis and other operations. The code analysis machine learning algorithm 176 may be implemented by unsupervised, supervised, and/or semi-supervised machine learning techniques.

The code analysis machine learning algorithm 176 may extract a set of component metadata 172 from each application 170 in question or suspected to be infected with malware. For example, a software application 170 may be fed to the code analysis machine learning algorithm 176 and the code analysis machine learning algorithm 176 may identify the components of the software application 170 and divide the components into smaller sections for evaluation. In this process, the code analysis machine learning algorithm 176 may use code segmentation, text segmentation, code tokenization, text tokenization, and the like.

The code analysis machine learning algorithm 176 may analyze the content of each section to identify various features and characteristics. For example, the code analysis machine learning algorithm 176 may determine the components 182 of each software application 170, including variables, parameters, code functions, classes, libraries, instructions, and other elements of each section of the software application 170.

The code analysis machine learning algorithm 176 may determine the component metadata 172 associated with the software application 170. The component metadata 172 may include each component identifier, each component usage pattern, entry and exit points of each component, dependencies between the components, and interactions with the operating system and other software applications, among others. The component metadata 172 may be represented by a metadata vector 180 that comprises numerical values that represent the component metadata 172 in the vector space.

Additionally, the code analysis machine learning algorithm 176 may implement feature selection methods to identify the relevant attributes from the metadata vectors 180 to distinguish between malicious and non-malicious activities and/or components that exhibit malicious activities that deviate from an expected baseline data. The code analysis machine learning algorithm 176 may be trained by a training dataset 232 that comprises a set of software applications 170, where each of these is labeled with its respective component metadata 172 and/or components 182. In the training phase, the code analysis machine learning algorithm 176 may use the training dataset to learn the associations between each software application 170 and its respective label. The code analysis machine learning algorithm 176 may adjust the parameters of its neural network, including bias and weight values of the perceptrons to reduce the error between the predicted output (predicted labels) and the actual labels provided in the training dataset 232 for each software application 170.

During the training process, the neural network iteratively processes each software application 170 and its label, and updates the bias and weight values through backpropagation to reduce the error in prediction of the corresponding label of each software application 170, until the prediction accuracy reaches a predefined percentage, e.g., more than 90%, etc. In response, in the testing phase, the code analysis machine learning algorithm 176 may use the updated bias and weight values of its neural network to apply its learning to new, unseen applications (e.g., software applications 170 without labels). The code analysis machine learning algorithm 176 may predict the likelihood that a given application (e.g., software application 170) includes malicious components by extracting its component metadata 172, comparing it to component metadata 144 of each malicious application 142. This process is described in conjunction with FIG. 2 in great detail.

The code analysis machine learning algorithm 176 may determine the behavior/operations of each software application 170, e.g., upon installation and/or during execution. For example, the code analysis machine learning algorithm 176 may determine the data flow associated with a given software application 170 (e.g., how the data is read, written, transmitted, modified, etc. by the application), interactions between the internal components of the given software application 170, and interactions between the given software application 170 and other applications and computing device 120 (e.g., function calls, library usage, memory access requests, directory access requests, etc.). The code analysis machine learning algorithm 176 may use this information to detect any indication of malicious activity, such as unexpected network connections, unauthorized access attempts, or unusual data flows, that deviates from expected behavior/operations.

The machine learning sequencing algorithm 178 may be implemented by the processor 162 executing the software instructions 168 and is generally configured to identify potentially malicious components 148. The machine learning sequencing algorithm 178 may comprise a support vector machine, neural network, random forest, k-means clustering, etc. The machine learning sequencing algorithm 178 may be implemented by a plurality of augmented neural network layers, neural network layers, convolutional layers, long-short-term-memory (LSTM) layers, Bi-directional LSTM layers, recurrent neural network layers, and the like. In some examples, the machine learning sequencing algorithm 178 may be implemented by a combination of deep learning architectures and neural networks for cluster distance analysis to identify malicious applications 142 that may be of interest as having the same or similar malicious component 148 as a given software application 170 in question. The machine learning sequencing algorithm 178 may be implemented by unsupervised, supervised, and/or semi-supervised machine learning techniques.

The machine learning sequencing algorithm 178 may rank and prioritize malicious applications 142 (in ascending order) based on the number of common components 148 that they have in common with a given software application 170. For example, the machine learning sequencing algorithm 178 may rank that have fewer components 148 in common with the software application 170 lower than the malicious applications 142 that have more components 148 in common with the software application 170.

### Operational flow for detecting and mitigating malicious software components

FIG. 2 illustrates an example operational flow 200 of system 100 (see FIG. 1) to detect and mitigate malicious software components (e.g., files, code, libraries, executable files, etc.) that may be used for unauthorized data exfiltration. The operational flow 200 may begin when the server 160 retrieves the malicious applications 142 stored in the database 140. In response, the server 160 clusters or classifies the malicious applications 142 that share more than a threshold percentage of common component metadata 144 and/or components 148 with each other. In this process, the server 160 may use the cleansing machine learning algorithm 174 to extract a set of component metadata 144 from each malicious application 142, similar to that described in FIG. 1. In response, the server 160, e.g., via the cleansing machine learning algorithm 174 may cluster the malicious applications 142 that share more than a threshold percentage of components 148 and/or more than a threshold percentage of component metadata 144 with each other. For example, the server 160 may generate a first cluster 210a that includes the malicious applications 142a and 142b, and generate a second cluster 210b that includes the malicious applications 142c and 142d.

With respect to the malicious applications 142a and 142b, the server 160 may extract the component metadata 144a from the malicious application 142a and extract the component metadata 144b from the malicious application 142b. In response, the server 160 may compare each component metadata 144a with the counterpart component metadata 144b and determine whether they share more than a threshold percentage 184 of components in common with each other. If it is determined that the malicious applications 142a and 142b share more than the threshold percentage 184 of components in common with each other, the server 160 may classify them together in the cluster 210a. The server 160 may perform similar operations to perform classifications for each malicious application 142. Each cluster 210a-b may include other malicious applications 142 as indicated by the three dots in each cluster. Similarly, the server 160 may generate any number of clusters 210 as indicated by the three dots between the clusters.

### Evaluating a software application

In the example of FIG. 2 assume that the software application 170 is requested to be evaluated to determine whether it is infected with a malicious component. For example, the server 160 may access the software application 170 by monitoring and detecting the presence, use, installation, and/or provisioning of software application 170 at the computing device 120. In the same or another example, the server 160 may receive a message 106 from the computing device 120 that indicates to evaluate the software application 170. The server 160 may proactively monitor and evaluate the software applications 170 residing at one or more computing devices 120 and/or upon request.

Within an organization, there may be thousands of software applications 170 being evaluated by cloud computing via the server 160 at any given time. In response, the server 160 may evaluate the software application 170. To this end, the server 160 may feed the software application 170 to the code analysis machine learning algorithm 176 to extract the component metadata 172 from the software application 170, similar to that described in FIG. 1. The output of the code analysis machine learning algorithm 176 may include the metadata vector 180 that includes numerical values representing component metadata 172 and the components 182 of the software application 170.

The server 160 determines to which malicious applications 142, the software application 170 is similar. This may be an indication that the software application 170 may include or be infected by a malicious component similar to the identified malicious application 142. The server 160 may compare the software application 142 with each malicious application 142 in terms of evaluation metrics 188. The evaluation metrics 188 may include component usage of each component, interaction points (including entry and exit points of each component where a given component interacts with other internal components and/or external applications and/or devices), among others. In this process, the server 160 may access the metadata vector 146 of each malicious application 142 (e.g., any of the malicious applications stored in each cluster 210).

The server 160 may use the machine learning sequencing algorithm 178 to identify the cluster 210 of malicious applications 142 to which the software application 170 is most similar in terms of evaluation metrics 188, based on the comparison of the metadata vector 180 of the software application 170 with each metadata vector 146 of each malicious application 142. For example, when comparing the software application 170 with the malicious application 142a, the server 160 may compare the metadata vector 180 with the metadata vector 146a. The metadata vector 180 may include numerical values representing the component metadata 144a and the components 148a of the malicious application 142a.

The server 160 may determine a distance (e.g., Euclidean distance) between the metadata vectors 146a and 180) in the vector space. If the distance is less than a threshold distance (e.g., less than 0.1, 0.01. etc.) the server 160 may determine that the malicious application 142a is similar to the software application 170 in terms of the evaluation metrics 188. The server 160 may perform similar operations between the software application 170 and each malicious application 142.

In some embodiments, the server 160 may implement the machine learning sequencing algorithm 178 to perform cluster distance analysis to identify the applications 142 of interest (that are more likely to share a malicious component with the software application 170) from the identified cluster 210a. In this process, the server 160 may determine one or more metadata vectors 146 whose each individual distance from the metadata vector 180 is less than a threshold distance, such as Euclidean distance, e.g., less than 0.2, 0.03, etc. The server 160 may rank the malicious application 142 within the identified cluster 210a based on their respective distances from the metadata vector 180 of the software application 170. Therefore, the malicious applications 142 with smaller distances (i.e., those that are more similar to the software application 170 based on the evaluation metrics 188) may be ranked higher than other malicious applications 142.

In response to the prioritization of the applications 142 of interest, the server 160 may prioritize the analysis of highly-ranked malicious applications 142 that are more similar to the software application 170 in terms of the evaluation metrics 188. In an example use case, the server 160, based on the comparison between the metadata vector 180 and metadata vector 146a, may determine that the software application 170 has more than a threshold percentage (e.g., more than 80%, 90%, etc.) of components 182 in common with the malicious application 142a. In response, the server 160 may identify a component 182 that is in common between the software application 170 and the malicious application 142a. The server 160 may evaluate the evaluation metrics 188 of each of the software application 170 and the malicious application 142a with respect to the component 182. For example, the server 160 may determine the first component usage associated with the component 182 by the software application 170. Similarly, the server 160 may determine the second component usage associated with the component 182 by the malicious application 142.

In another example, the server 160 may determine the first interaction points (including the entry and exit points where the component 182 interacts with the other components 182 of the software application 170, external software applications 170, components of the computing device where the software application 170 resides, among others.

Similarly, the server 160 may determine the second interaction points (including the entry and exit points where the component 182 interacts with the other components of the malicious application 142a, external software applications, components of the computing device where the malicious application 142a resides, among others. The server 160 may analyze each of the software application 170 and the malicious application 142a in terms of the evaluation metrics 188 with respect to each component 182 and 148a, respectively.

The server 160 may use this information to determine a similarity score 212 between the evaluation metrics 188 with respect to the software application 170 and the evaluation metrics 188 with respect to the malicious application 142a. In other words, the server 160 may determine the similarity score 212 between the first component usage of the component 182 by the software application 170 and the second component usage of the component 182 by the malicious application 142a, and between the first interaction points of the component 182 within the software application 170 and the second interaction points of the component 182 within the malicious application 142a.

If the similarity score 212 exceeds a predefined similarity score 214 (e.g., more than 80%, 90%, etc.), the server 160 may determine that the component 182 in the software application 170 is likely a malicious component similar to the counterpart component 182 in the malicious application 142a. The server 160 may perform similar operations between the software application 170 and each malicious application 142 to identify the most closely matching/corresponding malicious application 142a and/or suspiciously malicious component of the software application 170. For each comparison, the server 160 may determine a similarity score 212 between the software application 170 and each malicious application 142, iteratively, in series, or in parallel. In response, the server 160 may determine which malicious application 142a has the highest level of similarity score 212 with the software application 170. The server 160 may use this information to further evaluate the components of the software application 170.

The determination that the similarity score 212 between the first component usage and the second component usage is more than the threshold similarity score 214 may be based on analyzing the software application 170 in terms of the evaluation metric 188 with respect to the first component 182 in question. The first component 182 associated with a similarity score 212 more than the threshold similarity score 214 and/or is higher than other similarity scores 212 of other components may be an indication that the component 182 is potentially malicious. To confirm and further evaluate this indication, the server 160 may generate an instrumented component 190 that is configured to replace the potentially malicious component 182 within the software application 170 and monitor the behavior of the software application 170.

### Generating an instrumented component

In response to identifying the first component 182 that is associated with the similarity score 212 more than the threshold similarity score 214 and/or is higher than other similarity scores 212 of other components, the server 160 may generate an instrumented component 190 that is associated with the identified component 182. In some embodiments, the instrumented component 190 is configured, when executed by the processor 162 (see FIG. 1), to perform an expected non-malicious function of the first component 182. For example, if the first component 182 (that is determined to be potentially malicious) is a network DLL file (e.g., network.dll) for managing network communications for the software application 170, the instrumented component 190 may be configured to mimic the standard operations of the network DLL file, such as handing communications with other components of the software application 170, external devices, external applications 170, etc. In another example, if the first component 182 is a Java framework that provides a set of libraries for executing Java-based code, the instrumented component 190 may replicate the expected functionality of these libraries.

In some embodiments, the instrumented component 190 is configured, when executed by the processor 162 (see FIG. 1), to monitor interactions between the first component 182 and other components of the software application 170 and interactions between the first component 182 and the computing device 120 where the software application 170 resides. For example, the instrumented component 190 may monitor data exchanges, function calls, or any communication occurring between the first component 182 and other components of the software application 170 and between the first component 182 and computing device 120 where the software application 170 resides. In response, the instrumented component 190 may detect any deviations from the expected operation of the software application 170.

### Testing the software application

In some embodiments, the instrumented component 190 is configured, when executed by the processor 162 (see FIG. 1), to generate and simulate one or more test conditions 234 (also referred to herein as test cases) with respect to the first component 182. For example, the test conditions 234 may be configured to trigger/challenge the first component 182 to perform its operations, such as sending data, receiving data, sending network traffic to other devices, generating a directory folder, altering data inputs to other components of the software application 170, or triggering various internal functions, among others.

Thes test conditions 234 and/or inputs may be configured to trigger responses/interactions from the first component 182 in question. The test cases may be specific to each component 182 due to the nature of the different functions of each component 182. The server 160, e.g., via one or more of the machine learning algorithms described herein, may generate the test cases for each component 182 in question.

The server 160 may evaluate the operations of the software application 170 with respect to the first component 182 based on the simulation of the test cases with respect to the first component 182 in question. In some examples, the instrumented component 190 may include a wrapper DLL file, a dummy DLL file, and a machine learning-based DLL file, among others. In the example of the wrapper DLL, it may be configured to intercept inputs and/or outputs of one or more other DLL file, such as the network.dll. The wrapper DLL file may log the input and output data of one or more DLL files. In this way, the server 160 may observe the data flow and patterns of internal communications between the components 182 and external communications of the software application 170. This information may be used to determine the operations of the software application 170 and determine whether they deviate from the expected operations. In the example of a dummy DLL file, it may be configured to mimic the interface and communications of the potentially malicious DLL file (e.g., the first component 182 that is replaced with the dummy DLL file). This information may be used to simulate the behavior/operations of the software application 170 when it interacts with the dummy DLL under testing conditions.

In the example of the machine learning-based DLL file, the machine learning-based DLL file may be generated by a machine learning algorithm that is configured to generate a range of operations, such as unexpected, unconventional operations to interact with other components 182, external applications 170 and devices 120, and the computing device 120 where the software application 170 resides. The range of operations may include exploiting known security vulnerabilities, launching data requests, launching known attacks, e.g., brute force attacks, etc. This information may be used to simulate the behavior/operations of the software application 170.

In some embodiments, the server 160 may replace the first component 182 (suspected of being potentially malicious) with the generated instrumented component 190. The server 160 may execute the software application 170 with the instrumented component 190. The server 160 may monitor the behavior/operation of the software application 170 under the testing condition, e.g., in test sandbox 220 and determine the operations of the software application 170 with respect to the instrumented component 190, where the operation of the software application 170 with respect to the generated instrumented component 190 indicates whether the first component 182 has altered an expected operation of the software application 170.

The expected operation of the software application 170 may correspond to the predetermined operations where a non-malicious component (e.g., instrumented component 190) is used in the software application 170. If it is determined that the operation of the software application 170 deviates from the initial operation of the software application 170 where the first component 182 is implemented in the software application 170 (before the first component 182 was replaced with the instrumented component 190), the server 160 may determine that the first component 182 is a malicious component. Otherwise, the server 160 may determine that the first component 182 is not malicious. If it is determined that the first component 182 is malicious, the server 160 may execute a security patch 224 to address the malicious component 182. In some embodiments, the instrumented component 190 may not replace the suspected component 182 and added to the software application 170 in the testing environment to test the behavior of the suspected component 182 in response to triggers from the instrumented component 190 as described herein.

In some embodiments, the server 160 may generate the security patch 224 by creating a set of software instructions that are configured to address the malicious component 182. In some embodiments, the security patch 224 may comprise one or more software instructions configured to remove or disable the malicious component 182. In some embodiments, the security patch 224 may comprise one or more software instructions configured to update the software application 170 to restore the expected operation of the software application 170 by replacing the malicious component 182 with the instrumented component 190 or another authorized and secure software component that, when executed by the processor (e.g., processor 162 of FIG. 1), cause the processor to perform expected non-malicious operations of component 182. In some embodiments, the server 160 may configure the security patch 224 to restore any changes made by the malicious component 182, such as correcting changed settings, restoring corrupted data, etc. In some embodiments, the server 160 may configure the security patch 224 to delete, isolate, and/or quarantine the detected malicious component 182. The security patch 224 may be code, software instruction, and the like. The server 160 may generate and/or configure the security patch 224 in any suitable manner, e.g., based on user input, code generation based on sample code lines, natural language processing algorithms, generative text algorithms, and the like. The server 160 may deploy the security patch 224 by communicating the executable security patch 224 to computing devices 120 where the software application 170 resides and executing the security patch 224.

### Example method to detect and mitigate malicious software components

FIGS. 3A and 3B illustrate an example flowchart of a method 300 to detect and mitigate malicious software components, according to some embodiments. Modifications, additions, or omissions may be made to method 300. Method 300 may include more, fewer, or other operations. For example, operations may be performed in parallel or in any suitable order. While at times it is discussed that the system 100, computing devices 120, server 160, or components of any of thereof perform some operations, any suitable system or components of the system may perform one or more operations of the method 300. For example, one or more operations of method 300 may be implemented, at least in part, in the form of software instructions 168 of FIG. 1, stored on a tangible non-transitory machine-readable medium (e.g., memory 166 of FIG. 1) that when run by one or more processors (e.g., processor 162 of FIG. 1) may cause the one or more processors to perform operations 302-336.

Referring to FIG. 3A, at operation 302, the server 160 classifies the malicious applications 142 based on common components 148, similar to that described in FIGS. 1-2.

At operation 304, the server 160 identifies a cluster 120a of malicious applications 142 based on common components 148 with a software application 170, similar to that described in FIGS. 1-2.

At operation 306, the server 160 selects a first malicious application 142a in the cluster 210a, e.g., based on prioritization of malicious applications 142, similar to that described in FIGS. 1-2.

At operation 308, the server 160 identifies one or more components 182 that are common between a first malicious application 142a and a software application 170, similar to that described in FIGS. 1-2.

At operation 310, the server 160 selects a first component from among the one or more components 182.

At operation 312, the server 160 compares the first malicious application 142a with the software application 170 in terms of component usage and interaction points with respect to the first component 182 (included in the evaluation metrics 188). For example, the server 160 may compare the metadata vector 146a associated with the first malicious application 142a with the metadata vector 180 associated with the software application 170, similar to that described in FIGS. 1-2.

At operation 314, the server 160 determines a similarity score 222 between a first component usage and second interaction points at the software application 170 with a second component usage and second interaction points at the malicious application 142a with respect to the first component 182, respectively, similar to that described in FIGS. 1-2.

At operation 316, the server 160 determines whether the similarity score 222 is more than a threshold similarity score 214, similar to that described in FIGS. 1-2. If it is determined that the similarity score 222 is more than the threshold similarity score 214, the method 300 may proceed to operation 320. Otherwise, the method 300 may proceed to operation 318.

At operation 318, the server 160 determines whether to select another component 182. The server 160 may iteratively determine to select another component 182 if at least one component 182 is left from among the one or more components 182 that are in common between the software application 170 and the malicious application 142a, similar to that described in FIGS. 1-2. If it is determined that at least one component 182 is left for evaluation, the method 300 returns to operation 310. Otherwise, the method 300 proceeds to operation 320.

At operation 320, the server 160 determines whether to select another malicious application 142 in the cluster 210a. The server 160 may iteratively determine to select another malicious application 142 if at least one malicious application 142 is left in the cluster 210a. If it is determined that another malicious application 142 is left for evaluation, the method 300 may proceed to operation 306. Otherwise, the method 300 may end.

Referring to FIG. 3B, at operation 322, the server 160 generates an instrumented component 190 associated with the first component 182, similar to that described in FIGS. 1-2.

At operation 324, the server 160 replaces the first component 182 with the instrumented component 190, similar to that described in FIGS. 1-2.

At operation 326, the server 160 executes the software application 170 with the instrumented component 190, similar to that described in FIGS. 1-2.

At operation 328, the server 160 determines an operation of the software application 170 with respect to the instrumented component 190, similar to that described in FIGS. 1-2.

At operation 330, the server 160 determines whether the operation of the software application 170 with respect to the instrumented component 190 deviates from an expected operation, similar to that described in FIGS. 1-2. If it is determined that the operation of the software application 170 with respect to the instrumented component 190 deviates from the expected operation, the method 300 proceeds to operation 324. Otherwise, the method 300 proceeds to operation 322.

At operation 322, the server 160 determines that the first component 182 is not malicious.

At operation 324, the server 160 determines that the first component 182 is malicious. At operation 326, the server 160 executes a security patch 224 to address the malicious component 182, similar to that described in FIGS. 1-2.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f), as it exists on the date of filing hereof, unless the words “means for” or “step for” are explicitly used in the particular claim.

1. A system comprising:
a memory configured to store a first malicious application; and
a processor, communicatively coupled to the memory, and configured to:
extract first component metadata from the first malicious application, wherein the first component metadata comprises one or more component identifiers associated with one or more components of the first malicious application;
extract second component metadata from a first software application, wherein the second component metadata comprises one or more component identifiers associated with one or more components of the first software application;
compare the second component metadata with the first component metadata;
determine that the first software application has more than a threshold percentage of components in common with the first malicious application based at least in part upon the comparison between the second component metadata and the first component metadata;
in response to determining that the first software application has more than the threshold percentage of components in common with the first malicious application:
identify a first component that is common between the first software application and the first malicious application;
determine a first component usage associated with the first component by the first software application;
determine a second component usage associated with the first component by the first malicious application;
determine that a similarity score between the first component usage and the second component usage is more than a threshold similarity score based at least in part upon the first component usage and the second component usage;
generate an instrumented component associated with the first component, wherein the instrumented component, when executed by the processor, causes the processor to perform an expected non-malicious function of the first component;
replace the first component of the first software application with the generated instrumented component;
execute the first software application with the generated instrumented component;
determine an operation of the first software application with respect to the generated instrumented component, wherein the operation of the first software application with respect to the generated instrumented component indicates whether the first component has altered an expected operation of the first software application;
determine that the operation of the first software application deviates from an initial operation of the first software application where the first component is implemented in the first software application; and
in response to determining that the operation of the first software application deviates from the initial operation of the first software application where the first component is implemented in the first software application:
determine that the first component is a malicious component; and
execute a security patch to address the malicious component.

2. The system of claim 1, wherein the security patch comprises one or more software instructions configured to remove or disable the malicious component.

3. The system of claim 1, wherein the security patch comprises one or more software instructions configured to update the first software application to restore the expected operation of the first software application by replacing the malicious component with the instrumented component.

4. The system of claim 1, wherein the instrumented component, when executed by the processor, further causes the processor to:
monitor an interaction between the first component and other components of the first software application or a computing device; and
detect any deviations from the expected operation of the first software application based at least in part upon monitoring the interaction between the first component and other components of the first software application or the computing device where the first software application resides.

5. The system of claim 1, wherein the instrumented component, when executed by the processor, further causes the processor to:
simulate one or more test conditions or inputs with respect to the first component; and
evaluate the operation of the first software application with respect to the first component based at least in part upon simulating the one or more test conditions or inputs with respect to the first component.

6. The system of claim 1, wherein:
the processor is further configured to analyze the first software application in terms of an evaluation metric with respect to the first component, wherein the evaluation metric comprises the component usage and an interaction point associated with the first component, wherein the interaction point comprises one or more of an entry point or an exit point where the first component interacts with other components associated with the first software application or a computing device where the first software application resides; and
determining that the similarity score between the first component usage and the second component usage is more than the threshold similarity score is further based at least in part upon analyzing the first software application in terms of the evaluation metric with respect to the first component.

7. The system of claim 1, wherein:
the processor is further configured to analyze the first malicious application in terms of an evaluation metric with respect to the first component, wherein the evaluation metric comprises the component usage and an interaction point associated with the first component, wherein the interaction point comprises one or more of an entry point or an exit point where the first component interacts with other components associated with the first malicious application or a computing device where the first malicious application resides; and
determining that the similarity score between the first component usage and the second component usage is more than the threshold similarity score is further based at least in part upon analyzing the first software application in terms of the evaluation metric with respect to the first component.

8. A method comprising:
extracting first component metadata from a first malicious application, wherein the first component metadata comprises one or more component identifiers associated with one or more components of the first malicious application;
extracting second component metadata from a first software application, wherein the second component metadata comprises one or more component identifiers associated with one or more components of the first software application;
comparing the second component metadata with the first component metadata;
determining that the first software application has more than a threshold percentage of components in common with the first malicious application based at least in part upon the comparison between the second component metadata and the first component metadata;
in response to determining that the first software application has more than the threshold percentage of components in common with the first malicious application:
identifying a first component that is common between the first software application and the first malicious application;
determining a first component usage associated with the first component by the first software application;
determining a second component usage associated with the first component by the first malicious application;
determining that a similarity score between the first component usage and the second component usage is more than a threshold similarity score based at least in part upon the first component usage and the second component usage;
generating an instrumented component associated with the first component, wherein the instrumented component, when executed by a processor, causes the processor to perform an expected non-malicious function of the first component;
replacing the first component of the first software application with the generated instrumented component;
executing the first software application with the generated instrumented component;
determining an operation of the first software application with respect to the generated instrumented component, wherein the operation of the first software application with respect to the generated instrumented component indicates whether the first component has altered an expected operation of the first software application;
determining that the operation of the first software application deviates from an initial operation of the first software application where the first component is implemented in the first software application; and
in response to determining that the operation of the first software application deviates from the initial operation of the first software application where the first component is implemented in the first software application:
determining that the first component is a malicious component; and
executing a security patch to address the malicious component.

9. The method of claim 8, wherein the security patch comprises one or more software instructions configured to remove or disable the malicious component.

10. The method of claim 8, wherein the security patch comprises one or more software instructions configured to update the first software application to restore the expected operation of the first software application by replacing the malicious component with the instrumented component.

11. The method of claim 8, wherein the instrumented component, when executed by the processor, further causes the processor to:
monitor an interaction between the first component and other components of the first software application or a computing device; and
detect any deviations from the expected operation of the first software application based at least in part upon monitoring the interaction between the first component and other components of the first software application or the computing device where the first software application resides.

12. The method of claim 8, wherein the instrumented component, when executed by the processor, further causes the processor to:
simulate one or more test conditions or inputs with respect to the first component; and
evaluate the operation of the first software application with respect to the first component based at least in part upon simulating the one or more test conditions or inputs with respect to the first component.

13. The method of claim 8, wherein:
the method further comprises analyzing the first software application in terms of an evaluation metric with respect to the first component, wherein the evaluation metric comprises the component usage and an interaction point associated with the first component, wherein the interaction point comprises one or more of an entry point or an exit point where the first component interacts with other components associated with the first software application or a computing device where the first software application resides; and
determining that the similarity score between the first component usage and the second component usage is more than the threshold similarity score is further based at least in part upon analyzing the first software application in terms of the evaluation metric with respect to the first component.

14. The method of claim 8, wherein:
the method further comprises analyzing the first malicious application in terms of an evaluation metric with respect to the first component, wherein the evaluation metric comprises the component usage and an interaction point associated with the first component, wherein the interaction point comprises one or more of an entry point or an exit point where the first component interacts with other components associated with the first malicious application or a computing device where the first malicious application resides; and
determining that the similarity score between the first component usage and the second component usage is more than the threshold similarity score is further based at least in part upon analyzing the first software application in terms of the evaluation metric with respect to the first component.

15. A non-transitory computer-readable medium storing instructions that, when executed by a processor, cause the processor to:
extract first component metadata from a first malicious application, wherein the first component metadata comprises one or more component identifiers associated with one or more components of the first malicious application;
extract second component metadata from a first software application, wherein the second component metadata comprises one or more component identifiers associated with one or more components of the first software application;
compare the second component metadata with the first component metadata;
determine that the first software application has more than a threshold percentage of components in common with the first malicious application based at least in part upon the comparison between the second component metadata and the first component metadata;
in response to determining that the first software application has more than the threshold percentage of components in common with the first malicious application:
identify a first component that is common between the first software application and the first malicious application;
determine a first component usage associated with the first component by the first software application;
determine a second component usage associated with the first component by the first malicious application;
determine that a similarity score between the first component usage and the second component usage is more than a threshold similarity score based at least in part upon the first component usage and the second component usage;
generate an instrumented component associated with the first component, wherein the instrumented component, when executed by the processor, causes the processor to perform an expected non-malicious function of the first component;
replace the first component of the first software application with the generated instrumented component;
execute the first software application with the generated instrumented component;
determine an operation of the first software application with respect to the generated instrumented component, wherein the operation of the first software application with respect to the generated instrumented component indicates whether the first component has altered an expected operation of the first software application;
determine that the operation of the first software application deviates from an initial operation of the first software application where the first component is implemented in the first software application; and
in response to determining that the operation of the first software application deviates from the initial operation of the first software application where the first component is implemented in the first software application:
determine that the first component is a malicious component; and
execute a security patch to address the malicious component.

16. The non-transitory computer-readable medium of claim 15, wherein the security patch comprises one or more software instructions configured to remove or disable the malicious component.

17. The non-transitory computer-readable medium of claim 15, wherein the security patch comprises one or more software instructions configured to update the first software application to restore the expected operation of the first software application by replacing the malicious component with the instrumented component.

18. The non-transitory computer-readable medium of claim 15, wherein the instrumented component, when executed by the processor, further causes the processor to:
monitor an interaction between the first component and other components of the first software application or a computing device; and
detect any deviations from the expected operation of the first software application based at least in part upon monitoring the interaction between the first component and other components of the first software application or the computing device where the first software application resides.

19. The non-transitory computer-readable medium of claim 15, wherein the instructions further cause the processor to:
extract a third component metadata from a second malicious application, wherein the third component metadata comprises one or more component identifiers associated with one or more components of the third malicious application;
compare the first component metadata with the third component metadata;
determine that the first malicious application and the second malicious application have more than a threshold percentage of components in common with each other based at least in part upon the comparison between the first component metadata and the third component metadata;
cluster the first malicious application and the second malicious application together in response to determining that the first malicious application and the second malicious application have more than the threshold percentage of components in common with each other.

20. The non-transitory computer-readable medium of claim 15, wherein the instrumented component is a dynamic link library (DLL) or a Java code file.
